(19) United States
(12) Patent Application Publication
(10) Pub. No.: US 2015/0070886 A1
(43) Pub. Date: Mar. 12, 2015

(54) LED Light Has More Than One Optics Means Has Reflective Or/And Refractive Properties to Create Wider Viewing Angle Range Image

(71) Applicant: Tseng-Lu Chien, Walnut, CA (US)

(72) Inventor: Tseng-Lu Chien, Walnut, CA (US)

(21) Appl. No.: 14/323,318

(22) Filed: Jul. 3, 2014

Related U.S. Application Data
(63) Continuation of application No. 14/023,889, filed on Sep. 11, 2013.

(51) Int. Cl. F21S 10/06; F21S 10/02

(52) U.S. Cl. CPC F21S 10/063; F21S 10/023
USPC 362/231; 362/235; 362/232

(57) ABSTRACT

An LED light having different power sources including a battery, outlet plug-in power source, or interchangeable power source incorporates more than one of geometric shape optics means(es) has more than one reflective or refractive means(es) which has relative positions, distances, and/or orientations to create plurality of light beams reflect or retro-reflective or refractive by more than one reflector or refractor means(s), so the light beam(s) of the said LED or LEDs will reflective or/and refractive pass though the said more than one optics means(es) to create or project to surface(s) surrounding including ceiling, walls, floor and all desire areas with wider view angle image. At least one of the optics means has see-though and reflective or refraction surface(s) to permit the plurality of LED or LEDs light beam(s) passing through the optics means and also plurality of LED or LEDs light beam travel within or passing the optics means's reflective or refraction surface. An LED light device having power and cost saving features is optional be selected or be provided.

The current invention are CIP of co-inventor's co-pending filing or following projection light device including:

U.S. Ser. No. 13/______ LED light has kaleidoscope means, Filed on Sep. ______ 2013.

U.S. Ser. No. 13/021,124 LED light has changeable image and pattern by kaleidoscope means to project to surfaces. Filed on Feb. 4, 2011 and public on Aug. 9, 2012, 2012-0200-828.

U.S. Ser. No. 12-710,918 LED light has more than one reflector means, Now U.S. Pat. No. 8,8277,087 which similar with current invention to apply the kaleidoscope means which has more than one reflective means hereof use mirror or mirror-like means to assembly into kaleidoscope means.

U.S. Ser. No. 11-806,284 LED light has more than one optic means, now U.S. Pat. No. 7,632,004 which has use more than one optics means which similar with current invention to apply the optics means in front of or back of back of kaleidoscope means to create, adjust, magnify, reduce, enlarge the said the said image, LEDs light beams, LED lights' image, shape which including the any combination from optics lens, optics mirror, laser hologram, laser grating film, optics assembli

U.S. Pat. No. 7,455,444 LED light has more than one LED light source, the current invention use more than one LEDs for matrix arrangements with Circuit means, IC means, sensor means, switch means, brightness control means, color mix means, color selection means, color freeze means, motor means, gear means, turn-On and turn-Off means to make the certain number of LEDs turn-On with desired color, brightness, light brightness output, light functions, matrix combinations, motor means, rotating means, gear set means to pass though the said kaleidoscope means, optics means, laser mans, motor means, gear means, to has desired light patterns.

U.S. Ser. No. 12/948,953, U.S. Ser. No. 12/938,564 U.S. Ser. No. 12/886,832, U.S. Ser. No. 12/876,507, U.S. Ser. No. 12/771,003, U.S. Ser. No. 12/624,621, U.S. Ser. No. 12/914,584, U.S. Ser. No. 12/318,471, U.S. Ser. No. 12/318,470, U.S. Ser. No. 12/834,435 and also is continuous filing for co-inventor's prior filing cases as below issued patents:

U.S. Ser. No. 12/292,153 (now is U.S. Pat. No. 7,871,192),

U.S. Ser. No. 12/232,505 (now is U.S. Pat. No. 7,832,917),

U.S. Ser. No. 12/318,473 (now is U.S. Pat. No. 7,832,918). LED light has laser means

U.S. Ser. No. 12/624,621 (Now is U.S. Pat. No. 8,303,150) LED project light for Seasonal items

U.S. Ser. No. 12/771,003 (now is U.S. Pat. No. 8,408,736) Light device has More than one project means.

U.S. Ser. No. 12/876,507 (now U.S. Pat. No. 8,083,377) Light device has projection function with focus adjustable and project means can change position

U.S. Ser. No. 12/886,832 Digital data projection Light device, Sep. 8, 2010 filed

U.S. Ser. No. 12/938,564 Laser projection light device, Nov. 4, 2010 filed

U.S. Ser. No. 12/948,953 LED light has time projection. Nov. 13, 2010 filed.

U.S. Ser. No. 13/021,107 LED light has 3Dimensional projection, Feb. 4, 2011 filed.

Above listed Projection light device total has (9) projection light device are parent filing cases as CIP filing of the current invention.

### BACKGROUND OF THE INVENTION

Further more the Co-invention also has co-pending filing for light device has interchangeable power source for Wall outlets AC power and Energy storage means (Direct current) including the all kind of combination selection from prong mean, extension cord, adaptor, transformer, Solar, wind power, Batteries, chemical power, biologic power all can be interchange or for for any AC or battery power for Desk Top and Plug In type of current invention of project light device has build-in kaleidoscope means. The interchangeable co-filing cases as below:

U.S. Ser. No. 12/318,473,

U.S. Ser. No. 12/940,255 (Now U.S. Pat. No. 8,231,246) #FF-1

So the current invention are CIP for variety of co-inventor's co-pending or co-patents as above listed including: (1) Project light device (2) More than 1 optics means (3) More than 1 LEDs (4) More than 1 reflective means (5) Interchangeable power source (6) Laser Means (7) Adjustable focus and position changeable (8) motor & Gear set for moving adjustable.

This application has subject matter in common with U.S. patent application Ser. Nos. 12/710,561; 12/711,456; 12/771,003; 12/624,621; 12/622,100; 12/318,471; 12/318,470; 12/318,473; 12/292,153; 12/232,505; 12/232,035; 12/149,963; 12/149,964; 12/073,095; 12/073,889; 12/007,076; 12/003,691; 12/003,809; 11/806,711; 11/806,285; 11/806,284; 11/566,322; 11/527,628; 11/527,629; 11/498,874; 12/545,992; 12/806,711; 12/806,285; 12/806,284; 12/566,322; 12/527,628; 12/527,629; 12/527,631; 12/502,661; 11/498,881; 11/255,981; 11/184,771; 11/152,063; 11/094,215; 11/092,742; 11/092,741; 11/094,156. 11/094,155. 10/954,189; 10/902,123, 10/883,719; 10/883,747; 10/341,519; 12/545,992; and 12/292,580.

In particular, the following applications show light devices that have at least some features in common with included or optional features of the LED light device of the present invention: Ser. No. 12/710,561 (“LED power failure Light”); Ser. No. 12/711,456 (“LED light device has special effects”); Ser. No. 12/771,003 (“LED light device has more than 1 reflective means for plurality of image”); Ser. No. 12/624,621 (“projection device or assembly for variety of LED light”); Ser. No. 12/622,000 (“Interchangeable Universal Kits for all LED light”); Ser. No. 12/318,471 (“LED night light with pinhole imaging”); Ser. No. 12/318,470 (“LED night light with Projection features”); Ser. No. 12/318,473 (“LED night light with laser or hologram element”); Ser. No. 12/292,153 (“LED night light with Projection or imaging features”); Ser. No. 12/232,505 (“LED night light with Projection features”); Ser. No. 12/149,963 (“Removable LED light device”); Ser. No. 12/149,964 (“Surface Mounted Device with LED light”); Ser. No. 12/073,095 (“LED Track light device”); Ser. No. 12/073,889 (“LED light with changeable position with Preferable power source”); Ser. No. 12/007,076 (“LED light with changeable geometric system”); Ser. No. 12/003,691 (“LED light with changeable geometric dimension features”); Ser. No. 12/003,809 (“LED light with changeable features”); Ser. No. 11/806,711 (“Multiple LED light with adjustable angle features”); Ser. No. 11/806,285 (“LED Night light with outlet device”); Ser. No. 11/806,284 (“LED Night light with more than 1 optics means”); Ser. No. 11/527,628 (“Multiple function Night light with air freshener”); Ser. No. 11/527,629 (“LED Night light with interchangeable display unit”); Ser. No. 11/498,874 (“Area illumination Night light”); Ser. No. 11/527,631 (“LED Time piece night light”); Ser. No. 12/545,992 (“LED time piece Night light”); Ser. No. 12/292,580 (“LED Time Piece Night light”); Ser. No. 11/498,881 (“Poly Night light”); Ser. No. 11/255,981 (“Multiple light source Night Light”); Ser. No. 11/184,771 (“Light Device with EL elements”); Ser. No. 11/152,063 (“Outlet adaptor with EL”); Ser. No. 11/094,215 (“LED night light with liquid medium”); Ser. No. 11/094,215 (“LED Night light with Liquid optics medium”); Ser. No. 11/092,741 (“Night light with fiber optics”); Ser. No. 10/883,747 (“Fiber Optic light kits for footwear”); Ser. No. 11/498,874 (“Area Illumination for LED night light”); Ser. No. 11/527,629 (“Time Piece with LED night light”); Ser. No. 11/527,628 (“Multiple Function Night light with Air Freshener”); Ser. No. 11/806,284 (“LED Night light with more than one optics mediums”); Ser. No. 11/806,285 (“LED Night Light with multiple function”); and Ser. No. 11/806,711 (“Multiple LEDs Light with adjustable angle function”).

The applications of the inventor in general all apply physics or optics theory to a night light supplied with power from an outlet, battery, solar, or other power source. The present invention uses the physics or optics theory to create a plurality of LED light images on a surface. More specifically, the current invention uses more than one reflective means to transform a single LED spot light into a plurality of images on a surface to be seen by viewer. The principles of the invention may be applied to night lights of various types, including night lights disclosed in the above-listed patents and patent applications of the inventor, which may be powered by a variety of power sources, such as an outlet, batteries, solar, wind, or chemical power sources.

Because of the persistence of vision effect, caused by the human eye response time of more than 1/24 (41,67) to 1/16 (0.0625) seconds, when an object moves faster than the human eye response time, the last image will stay in the human eye and brain for an extended period of time. This theory can utilized to save power by causing an LED or LEDs to flash with a very short on-time of around 10 msec or less. This principle is similar to that of a motion picture in which, if an object in front of human eye is displayed in 16-24 pictures per second, people will think all pictures are continuous. Hence, the current invention uses a related circuit, control means, IC, and/or micro controller to cause an LED light device to blink at a rate that is much faster than 16-24 times (cycles) per second, with the LED or LEDs being turned on for 10% of each cycle and off for 90% of the cycle to save up to 90% of power consumption or increase battery life by nine times more than the full steady-ON condition. This is a significant power saving for all battery power source applications. It will be appreciated that new LEDs may be coming soon to enable the LEDs to have an even quicker response time of less than 10 msec, and possibly less than 5 msec or 2 msec, to provide even greater power saving. such adjustment of the duration of each cycle's turn-on and turn-off duration time will cause even more power saving to meet the green world concept. This is one of the very important concepts of the current invention.

Further cost saving can be achieved in the case of a battery powered unit by using a circuit with proper electric components, parts, and accessories to raise the voltage output of the batteries to trigger the LED or LEDs even though the number of batteries is less than that normally required to generate the required voltage. This can counter the tendency of people to use a large quantity of batteries and save substantial cost, which is another important advantage of the current invention.

A preferred embodiment of the current invention includes an LED night light with more than one reflective means within the geometric shape optics means that provide a plurality of LED light beams to passing through or reflecting within the more than one reflector means inside the optics means. The LED night light including at least one LED arranged on the inner of the partial transparency geometric optics means has more than one of the said reflective means, at least one second reflective means within the geometric optics means which can reflect an LED light beams from its surface to 1^{st} or others reflective means surface(s) back and forth so one LED light beams been reflected and travel within the optics means and partial of LED light beam are passing though the partial transparency optics means to outside.

In this embodiment, a plurality of the LED beam can be project outside though the said surface(s). Furthermore, at least one of the reflective means may be partially transparent so that the plurality of LED light beam is passing though from the said surface(s) thereof. The other Plurality of the light beam is been reflected or retro-reflected within the other reflector means and passing though some other surface(s).

The LED or LEDs of this embodiment are preferably connected with circuit means, power means, contact means, conductive means, switch means, sensor means, motor means, spin means, rotating means, gear set means, speed control means, printed circuit means, integrated circuit (I.C.) means and/or related parts and accessories to cause the LED or LEDs to turn on and off according to a predetermined time period, functions, colors, and/or effects to provide a desired lighting performance.

In the above-described preferred embodiment, the reflective means may be a mirror, chrome finished piece, polished piece, double-side mirror, or any surface having reflective and passing though both optics properties suitable to the current invention.

The partial transparent or see-though properties can be provided by a transparent piece, colored transparent piece, or any other piece that allows light beams to pass there through. A power source of this embodiment can be in the form of an outlet, batteries, solar power, chemical power, or wind power.

The LED or LEDs can be selected from any combination of single color, multiple color, multiple piece, standard, and special LED assemblies, LED number from 1 to N (N can be any number) to arrange in desire matrix spacing which available on the market.

Finally, the distance, position, orientation of the reflective means may be changed basing on the selected geometric shape of optics means. The LED or LEDs arrangement for different of LED number, position, color, IC chip, control means, circuit means, functions, and brightness can create a desire plurality of light patterns, show, color changing, images changing, moving effects to people to be seen on surrounding surface(s) including walls, ceiling, floor, or desire surface(s).

The said geometric optics means can has any shape with multiple construction and the said the geometric optics means has desire combination selected from the passing though lens, reflective lens, convex lens, concave lens, laser lens, hologram lens on the inner or outside surface or all side of the surface to make certain light effects.

According to another preferred embodiment of the invention, an LED light device having power saving features includes at least one LED or LEDs for a light source, at least one housing having space to install circuit means, conductive means, electric components parts and accessories, switch means, sensor means, an integrated circuit (IC), and/or a micro controller to connect with a conventional market-available power source to cause the LED or LEDs to turn on and turn to provide predetermined functions or effects, with a predetermined duty cycle, color, and/or brightness.

The power-saving features are obtained by using the control means to cause the LED or LEDs turn-on for only a certain percentage of each cycle. In particular, the turn on time is selected to meet the persistence of vision of the human eye, so as to take advantage of the human eye's response time of 1/24 to 1/16 second so that the blinking LED or LEDs looks as if it were continuously on.

According to yet another embodiment of the invention, an LED light device having cost saving features includes at least one LED or LEDs as a light source, at least one housing having space to install circuit means, conductive means, electric components parts and accessories, switch means, sensor means, an integrated circuit (IC), and/or a micro controller to connect with a conventional market-available power source, preferably batteries, to cause the LED or LEDs to turn on and turn off according to a predetermined function or effects, duty cycle, color, and/or brightness.

In this embodiment, cost saving is obtained by providing batteries having a total voltage that is less than the LED trigger voltage and by providing electric components and related parts and accessories to increase the voltage output of the batteries to greater than the LED trigger voltage.

As noted above, the current invention uses geometric shape optics-means has built-in more than one reflective means to create a plurality of LED light beam passing though, reflect, retro-reflect by the more than one of reflective means. The relative distance, position, and/or orientation of the more than one reflective means (and optional additional) reflective means will result in different light beam performance. This is a very low cost and simple way to make a splendid and eye catching light projection unit for people, with any desired power source such as a battery, USB power, outlet power, generator power, chemical power, solar power, wind power or other equivalent power source from the marketplace.

### BRIEF DESCRIPTION OF THE DRAWINGS

FIG. 1 and FIG. 2 and FIG. 2-1: shows a first preferred embodiment of the current invention has prong means with plenty of the reflective means inside the geometric optics-means and plenty of the convex-lens means to cause a plurality of light emit out to project the images to be seen by a viewer.

FIG. 1-1 and FIG. 2-2 and FIG. 2-3 shows a first preferred embodiment of the current invention has AC power-means with plenty of the reflective means inside the geometric optics-means and plenty of the convex-lens means to cause a plurality of light emit out to project the images to be seen by a viewer.

FIG. 1-2 and FIG. 2-4 and FIG. 2-5 shows a first preferred embodiment of the current invention has DC power-means or USB Power or interchangeable power source with plenty of the reflective means inside the geometric optics-means and plenty of the convex-lens means to cause a plurality of light emit out to project the images to be seen by a viewer. From FIG. 2-5 shows one of the splendid light images created by the current invention in a yellow color image.

FIG. 3 and FIG. 3-1: shows a preferred construction for an LED light has more than one reflect-means has motor means details construction . . . further illustrates the first preferred embodiment having first reflective means, a circuit board, conductive means, and an LED or LEDs arrangement.

FIG. 4 and FIG. 4-1 and FIG. 4-2: an arrangement of LED or LEDs light beam emit to the the first reflective means of the first preferred embodiment and hit to 2^{nd}, 3^{rd}, 4^{th} reflective means within the ball. The each reflect-means has convex shape outside so it act as convex-lens to allow the light beam to emit out to hays the project image to be seen. From FIG. 4 can see the first preferred embodiment's reflect-means has different distances, positions, and orientations for the first reflective means and second reflective means (or all other reflective means).

### DETAILED DESCRIPTION OF THE PREFERRED EMBODIMENTS

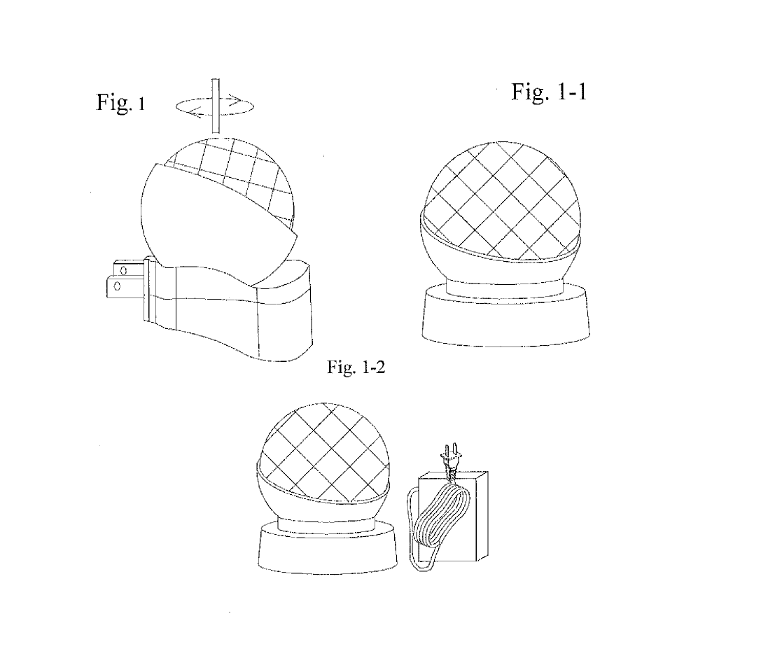

From FIG. 1, The LED project light has more than one reflect-means which has the Plug-In type has the prong means to connect with outlets from wall, extension cord, power stating, desk lamp outlets receptacles. The LED project light can project the light image to ceiling, walls, floor from the more than one optics-means construction. The optics-means has more than one convex lens construction basing on the inner has mirror-like polished reflector and outside are round convex shape so each become a convex-lens. Hence, the current invention 2 half geometric shape ball optics-means become a part of ball shape with build-in plurality of reflect-means and Optics-means and light beam emit out from LED head to hit the 1^{st} reflect-means, then, Hit 2^{nd}, 3^{rd}, 4^{th} . . . . Till the light beam are pass though to outside though the convex-lens.

From FIG. 1. The part of ball shaped optics-means project a splendid color image to all surrounding area because the current invention has construction of (s) the inner built-in more than one LEDs. The LEDs may selected from group of color, specification, size, functions and each LED can has its emit direction, orientation, angle to anywhere because the inner has more than one reflect-means as inventor's prior patented claims so the each LED light has different light emit direction even LED light emit angle is narrow but after the light beam been under may reflected then, the light will come out all over the ball shape . . . . This is the result basing (1) More than one LEDs (2) More than one Reflect-means (3) more than one optics-means (4) Interchangeable power source as inventor's all prior patents and co-pending all LED project light concept as above and below listed (9) co-pending and issued Prior arts.

Ser. No. 12/318,471, U.S. Ser. No. 12/318,470, U.S. Ser. No. 12/834,435 and also is continuous filing for co-inventor's prior filing cases as below issued patents:

U.S. Ser. No. 12/292,153 (now is U.S. Pat. No. 7,871,192),

U.S. Ser. No. 12/232,505 (now is U.S. Pat. No. 7,832,917),

U.S. Ser. No. 12/318,473 (now is U.S. Pat. No. 7,832,918). LED light has laser means

U.S. Ser. No. 12/624,621 (Now is U.S. Pat. No. 8,303,150) LED project light for Seasonal items

U.S. Ser. No. 12/771,003 (now is U.S. Pat. No. 8,408,736) Light device has More than one project means.

U.S. Ser. No. 12/876,507 (now U.S. Pat. No. 8,083,377) Light device has projection function with focus adjustable and project means can change position

U.S. Ser. No. 12/886,832 Digital data projection Light device, Aug. 8, 2010 filed

U.S. Ser. No. 12/938,564 Laser projection light device, Nov. 4, 2010 filed

U.S. Ser. No. 12/948,953 LED light has time projection. Nov. 13, 2010 filed.

U.S. Ser. No. 13/021,107 LED light has 3Dimensional projection, Feb. 4, 2011 filed.

Above listed Projection light device total has (9) projection light device are parent filing cases as CIP filing of the current invention.

From FIG. 1-1 show the Alternative Current (AC) power units which has the AC adaptor, transformer, AC wires to connect with units to get make the LED project light to have splendid project light image to be seen.

From FIG. 1-2 and FIG. 2-4 Show the Direct Current (DC) power unit which can have power from any Direct current device such as batteries, energy storage means, solar power, wind power, chemical power.

It is appreciated for the Interchangeable power source as the inventor prior art as above listed patent U.S. Pat. No. 8,434,927.

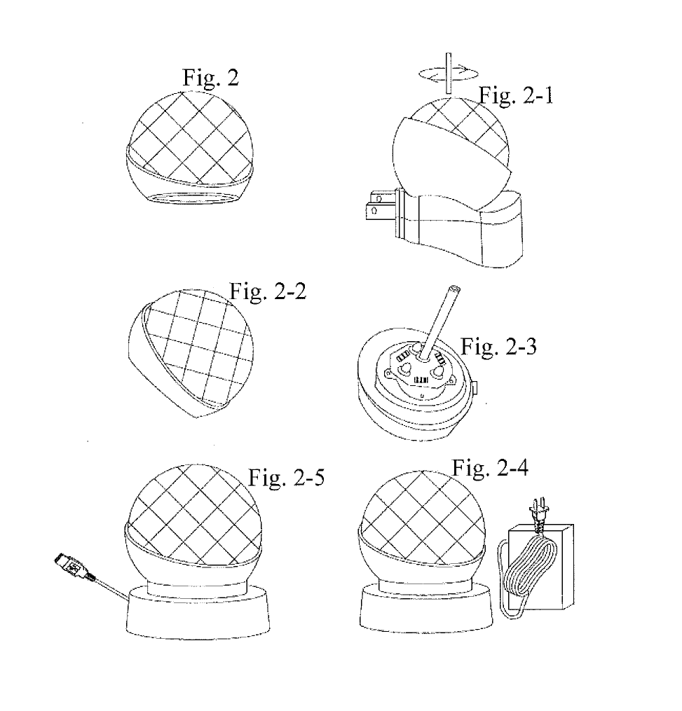

From FIG. 2 and FIG. 2-1 show the Plug-In type LED light device with base are install on the Plug-In housing to make the Alternative Current (A.C.) to drive the inner circuit means, LEDs, Sensor means, switch means, control means, and optional motor means to project the image to ceiling/walls/floor has penty of color and moving (If add the motor means).

The Said geometric shape optics-means has more than one reflect-means for the current FIG. 2 preferred LED light device has the sphere optics-means has plurality of flat mirror-polished reflect-means inside and has round convex surface out side of each reflect-means so it become a convex-lens. Not only can reflect the light beams also can allow light beam pass though.

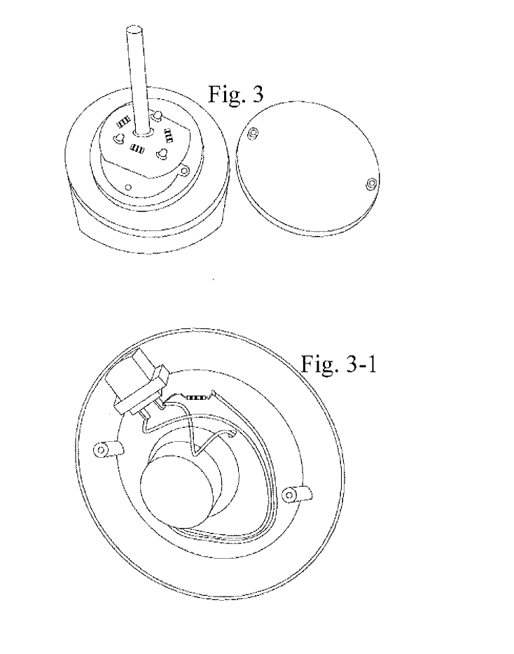

From FIG. 2-2 and FIG. 2-3: Show the Alternative Current (A.C.) type power unit has recetpacle to receiving transformer, adaptor or AC wires. Adaptor or AC wires to drive the circuit, LEDs to make the LEDs turn on and project light to desire area(s). It also can use USB wire to get power from the USB Port as FIG. 2-5.

From FIG. 3: The project light has more than one reflective-means within one optics-means to allow light pass though the convex-lens and reflect within the reflective-lens to project the image on ceiling, walls, floor.

From FIG. 3-1: Show the inner construction for one of preferred the Project light has built-in motor means how to fix the motor means on the housing by screw. It also show the motor means has work with gear-set means to reduce the motor's rotating speed to slower speed to prevent from people uncomfortable to see quickly moving image on ceiling, walls, floor.

It also show the switch means, electric parts & accessories, conductive wires to connect with circuit means and the get the power source constructions.

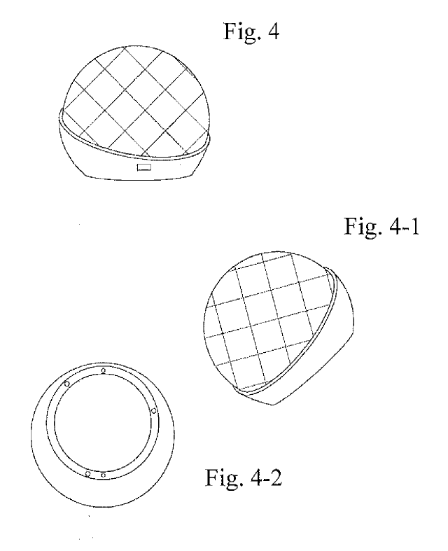

From FIG. 4: Show the Light beam reflect within the more than one reflect-means which on inner of the optics-means which are in the shape of sphere. Also, the light beam pass though the outside convenx-lens to project the image to the ceiling, walls, floor. This embodiment teach (1) more than one reflect-means in optics-means (2) light project though the more than one optics-means which the inner side is a flat mirror-polished reflector and outside is convex-shape so it is a convex-lens (3)each convex lens get together to form a semi-sphere geometric shape. (4) 2 half-sphere ball.

From FIG. 4-1: Show the other viewing angle for the 2 half-shaped sphere with base to form the optics-means which has more than one optics-means. The each one of the optic-means has more than one reflect-means to form the half-sphere geometric ball. This is same concept with inventor's earlier U.S. Pat. No. 7,632,004 LED night light hase more than one optics means. U.S. Pat. No. 8,277,087 has more than one reflect means. U.S. Pat. No. 7,455,444 LED night light has more than one LED. U.S. Pat. No. 8,434,927 interchange power source for current invention scope.

From FIG. 4-2: Show the inner side of the 2 shape optical-means which has more than one reflect-means inside of the each of optics-means so can overcome LED's narrow light beam angle. The current invention all LEDs has different direction to emit the light beam to reflect-means even the light angle is narrow it is not a problem because the light emit from LED head will hit the 1st reflect-means, then hit to 2nd, 3rd, 4th . . . reflect-means till the light beam been 100% pass though convex-lens so this is current features too!

Add motor can make the image be rotating to get moving image to viewer. The construction.

In the preferred embodiments, images are created based on the relationship between the first reflective means and the second reflective means or all other reflective means. The light device can employ any kind of design, shape, display, or geometric arrangement of the more than one reflective means.

Although specific preferred embodiments of the current invention are described above, it is to be appreciated that all alternative, equivalent, same-function and/or same-skill-or-theory variations, modifications, replacements, arrangements, or constructions may still fall within the current scope of the invention.

1. An LED light having more than one optics means has reflective and/or refract properties to create Wider Viewing Angle or range image comprising:
at least one LED;
at least one of optics means has partial transparency or translucent geometric shape has more than one reflective or refractive means and its optics-properties surface; and
The said reflective or refractive means having a reflecting or refractive surface for reflecting or refractive light from the said LED or LEDs. The said optic-means also has more than one of light beam passing though surface(s) to allow light beam passing through to create a wider range image been viewing and create or project to surrounding surface(s) including ceiling, walls, other surfaces(es) while install on desk-top or plug-into wall outlets or extension cords or connect with the power source.
The LED or LEDs can be selected from any combination of single color, multiple color, multiple piece, standard, and special LED assemblies, LED number from 1 to N (N can be any number) to arrange in desire matrix spacing which available on the market.
The LED or LEDs are preferably connected with parts & accessories in any combination from circuit means, power means, prong means, USB wire means, battery means, AC power means, contact means, conductive means, switch means, sensor means, motor means, spin means, rotating means, gear set means, speed control means, printed circuit means, integrated circuit (I.C.) means and/or related parts and accessories to cause the LED or LEDs to turn on and off according to a predetermined time period, functions, colors, and/or effects to provide a desired lighting performance.
wherein said at least one LED are connected to a power source by conductors and circuitry including means for causing said at least one LED to turn on and off for a predetermined period to provide predetermined functions, colors, and effects.
The said LED light create or project image from LED light source(s) emit light beam passing though the more than one of reflect-means or refraction-means OR more than one optics-means to desired surface.

2. An LED light having more than one optics means has reflective and/or refract properties to create Wider Viewing Angle or range image as recited in claim 1, wherein said reflective or refractive means is selected from the group consisting of a mirror, chrome-finished piece, fine-polished piece, and double-sided mirror or any reflective or refractive optics means related parts and/or accessories . . . .

3. An LED light having more than one optics means has reflective and/or refract properties to create Wider Viewing Angle or range image as recited in claim 1, wherein said see-through properties are provided by a transparent or colored transparent piece of reflective or refractive means has desired optics properties with preferred texture, thickness, variable thickness, convex or concave or desired lesn(s).

4. An LED light having more than one optics means has reflective and/or refract properties to create Wider Viewing Angle or range image as recited in claim 1, wherein said power source is selected from the group consisting of an outlet, batteries, solar power, chemical power, and wind power or market available energy to provide electricity though related circuit means to drive said at least one LED to emit light beams.

5. An LED light having more than one optics means has reflective and/or refract properties to create Wider Viewing Angle or range image as recited in claim 1, wherein additional motor means and gear set means fit within the LED light to make or create or project the Moving image(s) functions, effects, performance for wide range or space to be seen.

6. An LED light having more than one optics means has reflective and/or refract properties to create Wider Viewing Angle or range image as recited in claim 1, wherein said at least one LED is selected from a single or multiple color LED, a multiple piece LED, a standard LED, and a custom LED assembly.

7. An LED light having more than one optics means has reflective and/or refract properties to create Wider Viewing Angle or range image as recited in claim 1, wherein said the LED light models which has emit or projection LED light beams to more than one surface including for Desktop or plug-in Wall outlet, receptacles, extension cord, Power strip or cigarette light application or models.

8. An LED light having more than one optics means has reflective and/or refract properties to create Wider Viewing Angle or range image as recited in claim 1, wherein said the geometric optics means has desire combination selected from the passing though lens, reflective lens, refractive lens, convex lens, concave lens, laser lens, hologram lens with preferred texture, polish finish surface, thickness, curvature, shape for the inner or outside surface or all side of the surface to make certain light effects.
